(19) United States
(12) Patent Application Publication
(10) Pub. No.: US 2016/0337358 A1
(43) Pub. Date: Nov. 17, 2016

(54) METHOD FOR ENCODING AN ACCESS TO A COMPUTER RESOURCE

(71) Applicant: MOBILEAD, Paris (FR)

(72) Inventors: Laurent Tonnelier, Paris (FR); Ludovic Lebas, Melun (FR)

(73) Assignee: Mobilead, Paris (FR)

(21) Appl. No.: 14/909,236

(22) PCT Filed: Aug. 1, 2014
(86) PCT No.: PCT/FR2014/052016

§ 371 Date: Aug. 4, 2016

(30) Foreign Application Priority Data
Aug. 2, 2013 (FR) 1357709

(51) Int. Cl. H04L 29/06; G06F 17/30; G06Q 30/02; G06K 7/10; G06K 7/14

(52) U.S. Cl. CPC H04L 63/10; G06K 7/10297; G06K 7/1417; G06Q 30/0225; G06F 17/30879

(57) ABSTRACT

A method for coding an access to a computer resource comprises, in a physical representation of a code, first information encoded with a first coding type corresponding to an access path and to an identification of said computer resource, and fit to be decoded by a reader, wherein said physical representation further comprises conditional validity information encoded with a second coding type corresponding to a condition of validity of an access to said computer resource, with said conditional validity information fit to be decoded by an application installed in one element of the network including the reader of the physical representation, one or more gateway(s) and the server hosting said computer resource.

### BACKGROUND OF THE INVENTION

The present invention relates to the field of information processing and more particularly the access to a computer resource from a piece of encoded information, for instance an optical reading code of the QR code type, or a radiofrequency reading code of the NFC or RFID types, or a steganographic marking such as a watermark or an audio coding.

US patent application published as US20130091002 is known in the state of the art, and describes a system and methods for verifying the validity of a coupon provided with an associated coupon code. The coupon code has at least an encoded URL and an encrypted unique coupon identifier. A scanner scans the encrypted unique coupon identifier on the coupon and accesses a verification server via the URL. The verification server decrypts the encrypted unique coupon identifier and determines whether the decrypted unique coupon identifier is a valid coupon identifier.

PCT application published as WO201354058 provides for a method of carrying out an electronic transaction corresponding to a requested service, the method comprising the steps of:

receiving by a server of a first terminal a request for creation of an electronic transaction corresponding to a requested service;

saving in the server a first information (I1) about said electronic transaction;

dispatching from the server to the first terminal the first information (I1) about said electronic transaction;

generating by the server a transaction code (QR-C) comprising an identifier (ID) of said electronic transaction;

dispatching by the server the transaction code (QR-C) to the first terminal;

scanning said transaction code (QR-C) by means of a second terminal;

dispatching from the server to the second terminal a second information (I2) about said electronic transaction on the basis of the scanned transaction code (QR-C);

receiving by the server a personal identification number (PIN) and an information validation item (IVAL) for the electronic transaction which are dispatched by the second terminal;

dispatching a confirmation of electronic transaction from the server to the first terminal and to the second terminal.

US patent application published as US20120323665 describes a computer-readable code for coupon verification. The method for operating this code consists in receiving from a coupon verification terminal via a mobile network a verification data package based on at least additional verification information and a verification code of a coupon.

European patent application published as EP2509275 describes a system for authenticating an entity. Users (A, B) are provided with sets of authentication codes (3-5), each set comprising at least one secret (3), a private key QR-code (4) and a matching public key QR-code (5), the private and public key QR-codes being QR-codes generated from respectively a first string (1) comprising an URL of an authentication server system (10) and a PKI private key and a second string (2) comprising the same URL and a matching PKI public key. Upon receipt on the authentication server system (10) of one of the first strings (1) as a result of a first user scanning the respective private key QR-code (4), an action definition procedure is performed wherein the first user is requested to enter a secret (3) of the same set of authentication codes (3-5). If a check returns a positive result, the first user can define a set of actions to be performed upon receipt of the second string (2) belonging to the same set of authentication codes on the authentication server system (10).

US patent application published as US20130041734 describes a method of redeeming coupons using a mobile phone. The method generally comprises a method wherein a Uniform Resource Locator (URL) is electronically transferred to a mobile phone device for the purpose of allowing conditional access to coupons, premiums or discount offers.

U.S. Pat. No. 8,245,932 describes a method of reading at least one bar code carried by a substrate, the method comprising:

a) generating, especially in an automatic manner, when presenting the bar code to a system for reading the bar code, at least one authentication information element related to an intrinsic physical characteristic of the substrate and independent of the data contained in the bar code, and

b) allowing the reading of the bar code, only in the event of a positive authentication of the substrate, or reading the bar code regardless of the result of the authentication of the substrate and in the event of negative authentication of the substrate, preventing access to just one part of the data contained in the bar code and/or to any data that may be associated with the bar code, and which is stored on a data medium different from the substrate.

Known solutions of the prior art imply the access to a centralized and remote database server for processing the information contained in the code. Because of the swift multiplication of the number of codes, such solutions require very important storage and processing capacities to be provided in these servers, mainly for former codes which are no longer active.

More particularly, EP2509275 implements a “conventional” QR code, the decoding of which leads to the opening of a session with a computer resource installed on a server, and making a PKI type authentication from the parameters contained in the sequence decoded by the QR code reader.

The registration of a user necessitates a generation of a pair of QR codes corresponding to the public key and the private key.

The purpose of the patent is not to define a condition for the code validity but to identify a user.

The code will remain valid and will always provide access to the computer resource executing the authentication, unlike the invention. It requires the permanent availability of the authentication computer resources, with the QR Code having an unconditional validity and it shall always give access to the remote resource for operating this known solution of the prior art.

Such solutions of the prior art thus result in a useless saturation of the servers and affect the access time.

Another drawback of some solutions of the prior art resides in that they require a dedicated reader, comprising a specific decoding application.

Eventually, most of the known solutions do not make it possible to operate the code without an access to the network and to the server.

### SUMMARY OF THE INVENTION

In order to remedy such drawbacks, the invention, in its broadest sense, relates to a method for coding an access to a computer resource encoded with a first coding type corresponding to the access path and to the identification of said computer resource, and able to be decoded by a reader, characterized in that:

said physical representation further comprises conditional validity information encoded with a second coding type corresponding to a condition for validity of the access to said computer resource,

with said conditional validity information being able to be decoded by an application installed in one element of the network comprising the reader of the physical representation, one or more gateway(s) and the server hosting said computer resource.

Advantageously, the invention relates to a method for coding an access to a computer resource consisting in including, in a physical representation of the code, first information encoded with a first coding type corresponding to the access path and to the identification of said computer resource, with said first information being able to be decoded by the reader, characterized in that said physical representation further comprises conditional validity information encoded with a second coding type corresponding to a condition for validity of the access to said computer resource, with said conditional validity information being able to be decoded by an application installed in one element of the network comprising the reader of the physical representation, one or more gateway(s) and the server hosting said computer resource.

Said access is preferably encoded with one code semantically representative of a field of application.

Advantageously, said conditional information is time information corresponding to at least one period of validity of the access to said computer resource.

According to an alternative solution, said conditional information is geographic information corresponding to geo-location information as compared to position information determined by the reader.

According to another alternative solution, said conditional information actuates a request for at least one additional data and the comparison with data associated with said conditional information.

According to an alternative solution, said conditional information actuates a request for at least one additional data and the comparison with data associated with said conditional information, within a predetermined response time.

According to a particular embodiment, the computer resource for decoding said conditional information comprises a grammar of a field of application.

Advantageously, said conditional information actuates a request for at least one additional data and the comparison with data associated with said conditional information, according to the result of another request.

According to an alternative solution, said conditional information is processed by the reader, and not by the server.

According to an alternative solution, said conditional information is processed by the gateway, and not by the server.

According to a particular embodiment, said code is decoded by a reader transmitting said first information to the network, when said reader has no computer resource to decode said conditional information and said first information is transmitted to the server corresponding to the access path only when the conditional information is validated by at least one of the elements of the network having a computer resource in order to decode said conditional information.

According to an alternative solution, said reader comprises an application for decoding the conditional information to execute a local processing controlling a local interface according to the result of the analysis of said conditional information.

Advantageously, said reader comprises an application for decoding the conditional information to execute a local processing controlling a remote action according to the result of the analysis of said conditional information.

Preferably, the computer resource for decoding said conditional information comprises at least a Database for saving exceptions to the condition for validity.

The invention also relates to IT hardware comprising a physical representation integrating the code of first information encoded with a first coding type corresponding to the access path and to the identification of said computer resource, with said first information being able to be decoded by a reader, characterized in that:

said physical representation further comprises conditional validity information encoded with a second coding type corresponding to a condition for validity of the access to said computer resource,

with said conditional validity information being able to be decoded by an application installed in one element of the network comprising the reader of the physical representation, one or more gateway(s) and the server hosting said computer resource.

It also relates to the network element directly associated with the implementation of the above method.

### BRIEF DESCRIPTION OF THE DRAWINGS

The present invention will be better understood when reading the following description, which corresponds to non limitative exemplary embodiments illustrated by the appended drawings wherein:

FIG. 1 shows a schematic view of the processing executed according to the state of the art;

FIG. 2 shows a schematic view of the processing executed according to a first alternative solution of the invention;

FIG. 3 shows a schematic view of the processing executed according to a second alternative solution;

FIG. 4 shows a schematic view of the flows of information exchanged between the network components, from the programming to the production of physical supports;

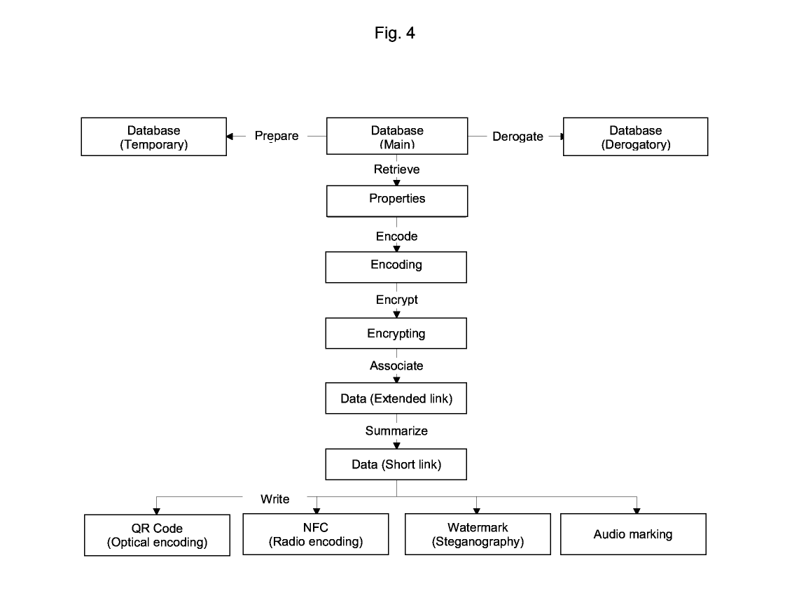

FIG. 5 shows a schematic view of the flows of information exchanged between the network components, from the programming to the management of the properties thereof,

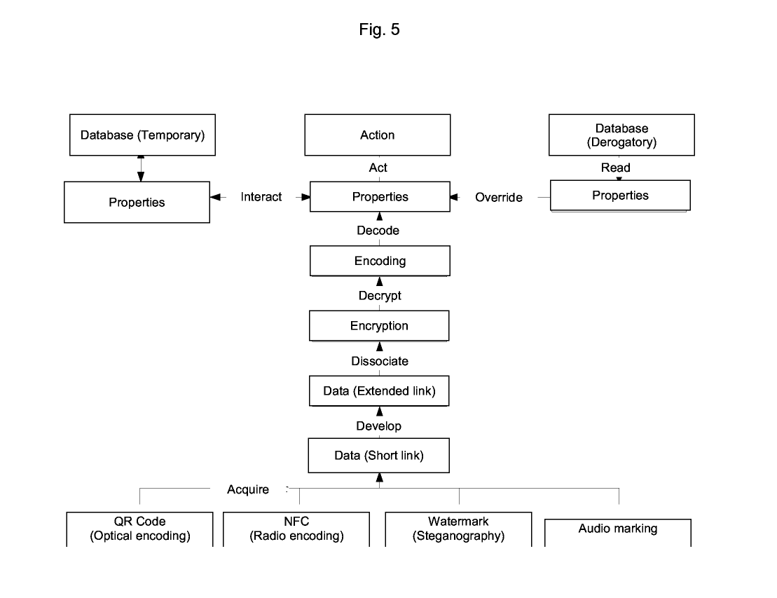

FIG. 6 shows a schematic view of the method for producing and operating the codes according to the invention.

### DETAILED DESCRIPTION

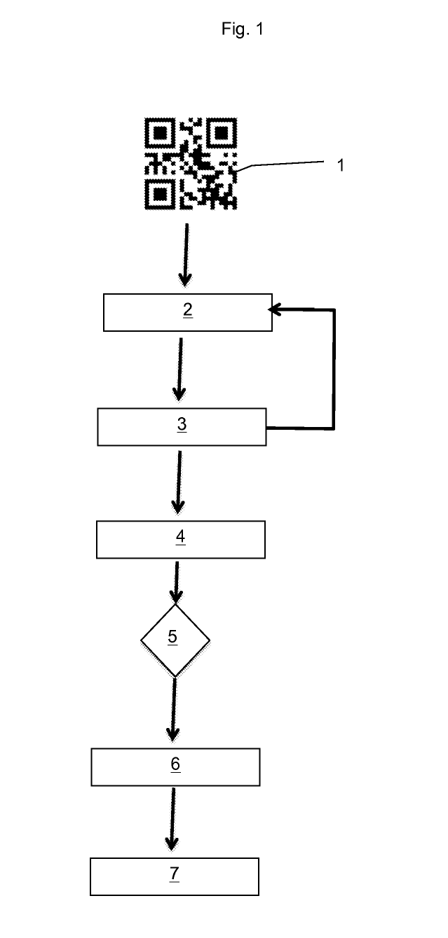

FIG. 1 shows a schematic view of the processing executed to operate a QR code, which corresponds to one of the non restricting physical representations used by the invention.

This code is characterized by a two-dimensional array printed on a support, with a standardized structure to enable the recognition thereof by applications installed in and executed by any equipment having an optical sensor, for example a tablet or a cell phone.

This application is installed on the equipment and activated by the user.

When an image is positioned in front of the sensor, the application executes a first operation 2 consisting in capturing the image to save it in the random access memory of the equipment.

The following operation 3 consists in analyzing such information to check whether the pattern thereof is compliant with the specifications of a QR code, and, failing that, to resume the acquisition.

If information is recognized as a QR code, a step of decoding 4 is executed to save the alphanumeric sequence corresponding to the analyzed QR code 1.

The following step 5 consists in checking whether this alphanumeric sequence corresponds to a computer address of the URL type.

If it is a URL, the application executes a step 6 of opening an application of the Internet browser type, and of access to the remote resource corresponding to the address decoded in step 4.

Then, the application operating the QR code switches to standby and the server 7 executes the processing corresponding to the decoded address, for instance to send a HTML file to the browser in the user's equipment.

As mentioned above, the resource 7 must be permanently available to enable the processing of the emitted QR codes, to avoid generating mistakes.

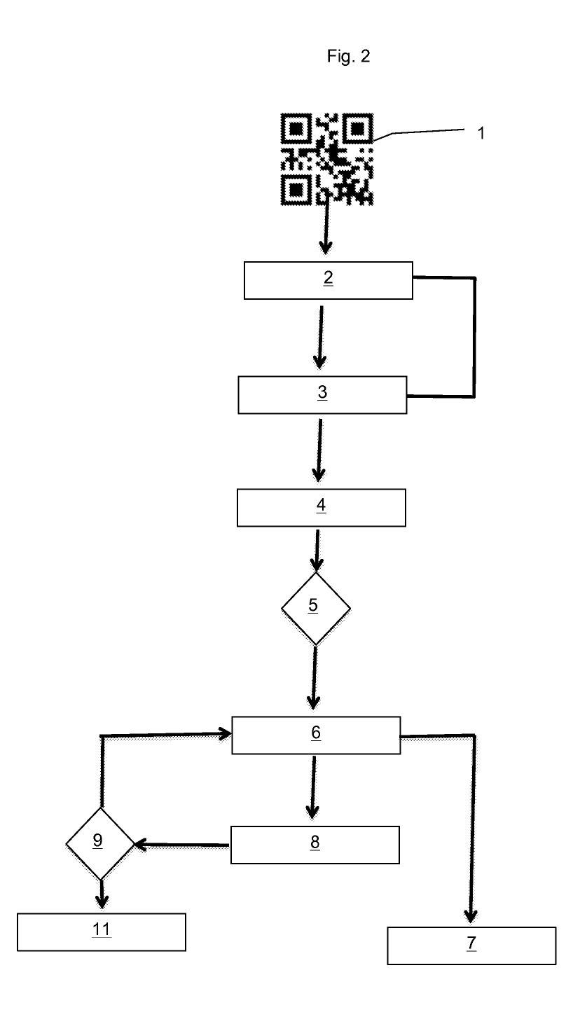

FIG. 2 shows the processing executed for implementing the invention according to a first alternative solution.

In this embodiment, the equipment (tablet, telephone, and the like) operates a “standard” QR Code processing application.

The initial steps of capturing 2 and analyzing 3, QR code decoding 4 and checking 5 and opening a browser 6 are executed as per the standard solutions of the state of the art.

The difference lies in that the URL address is not that of the destination server, but that of a problem-solving server 8 corresponding to the decoded sequence.

This problem-solving server 8 executes an application which is specific to the invention, consisting in decoding the second information contained in the sequence transmitted to the problem-solving server 8 and in determining whether the condition for validity is verified or not. Only if the condition for validity mentioned in the second information is verified, the problem-solving server 8 sends the browser to a remote server 7 the address of which corresponds to the first information.

Failing that, step 9 generates an alternative link, for instance, with a server 11 supplying a message saying the code is not valid. This server may be common to all the non valid codes generated by an entity. This makes it possible to reduce the processing load of the main server, which will be used for the valid codes only, with all the other obsolete or non valid codes, with respect to the second information, being processed by the second server 12.

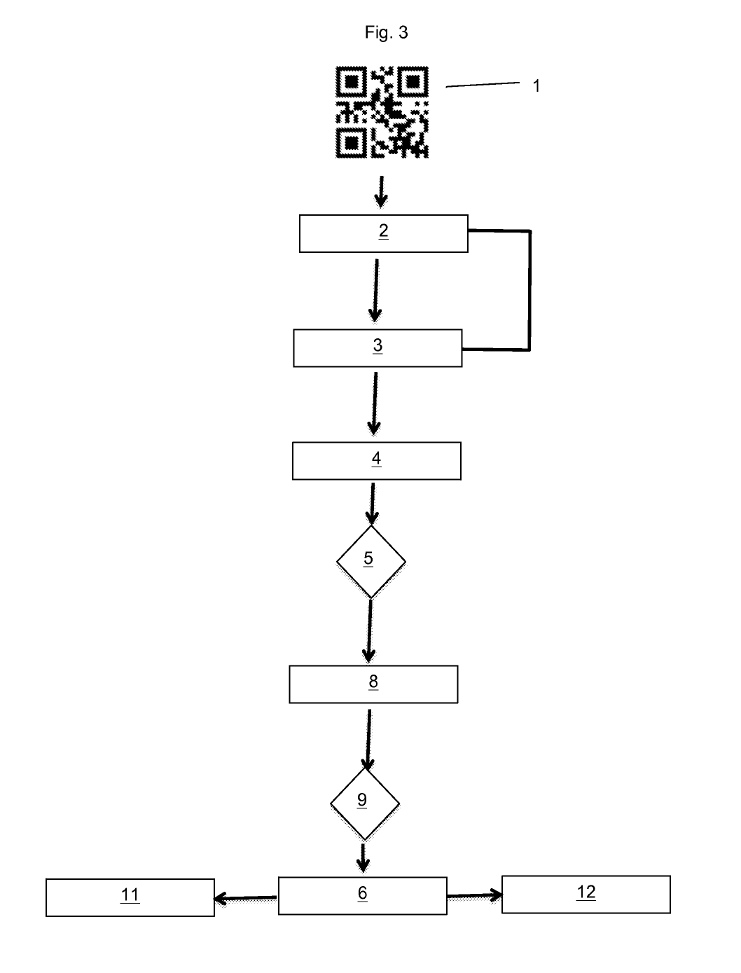

FIG. 3 shows an alternative embodiment wherein an application specific for the invention is installed on the equipment instead of a standard QR code reading application.

In this case, the second information is not decoded by a remote server but locally by the specific application installed on the reading equipment. If the second information is verified, the application opens the browser during a step 6 and transmits the address of the remote computer resource 7 corresponding to the first information.

If, conversely, the condition for validity determined by the second information is not verified, the application opens the browser at step 6 and transmits the address of a local or remote computer resource 11 supplying a message saying it is not valid, and this server may be common to all the obsolete or invalid codes of a same code producer.

For a locally-generated message, the address of this computer resource will be of the URI type.

For a message generated by a remote server, the address of this computer resource will be of the URL type, for instance.

The access path to the remote computer resource 7 can be so calculated as to be specific for each product whereto a QT code is applied. It consists of a combination of the product identifier, for instance the GTIN (“global trade item number”) identification code thereof, or in case of a book an ISBN (International standard book number) code, and characteristic descriptors such as the production date, or the best before date.

A first exemplary embodiment relates to the production of physical supports, the operating time of which is limited in time. These may be, for instance, QR codes associated with a marketing campaign, enabling a consumer to access in line to a commercial offer from the acquisition of a QR Code data, using his/her cell phone.

For this purpose, a Database is created, which comprises all the properties of each code, an identifier, the validity start date and the validity end date, the destination URL during the security life and the destination URL beyond the security life.

A record is then retrieved from the Database for each code. The various properties of each record are then encoded. Then a prefix corresponding to the protocol and to the address of the operating server is then associated with the encrypting of the obtained numerical form, in order to form one URL per code.

Each URL is then written on a physical support, for instance an optical reading code such as a QR code.

These codes are operated as explained hereunder.

The user reads a code printed on a physical support, for instance a packaging, using his/her mobile phone, for instance a cell phone.

The mobile device comprises a generic application for reading the QR code, which supplies the URL address saved in the acquired code.

The reader launches the internet browser which connects to the operation server indicated in the code. The operation server decrypts and decodes the parameter communicated, in order to retrieve the information relative to the security life, as well as the destination URL address during the validity period and the destination URL address beyond the validity period.

The operating server checks the condition for validity as a function of the system clock and the decrypted and decoded information, and controls the transmission to one of the two destination URLs as a function of the result of such verification.

According to one alternative embodiment, the marketing campaign operator still has the capacity of departing from the validity rules.

For this purpose, it can use a complementary Database for saving the derogatory situations.

The operating server executes, like in the general case, a code analysis to retrieve the validity information and the destination URLs.

The validity information is verified not only with respect to the static information written in the code, i.e. local information, but as regards dynamic information calculated as a function of the information saved in the derogatory base and the decrypted and decoded information.

The dynamic information will be, for instance, a URL modified by a processing, as a function of the decrypted and decoded URL and information from the derogatory base.

According to a second alternative embodiment, an authorized user may access the static information written in the code, i.e. local data.

The authorized user then reads a code printed on a physical support, for instance a packaging, using a mobile terminal, for instance his/her cell phone.

The mobile terminal includes a QR code reading specific application which supplies the URL address saved in the acquired code. The local application has a key which can decrypt, or even a grammar which can decode the parameter-conditional code of the URL.

The contextual parameters include the system clock and the geographic position, as well as the mobile language(s), the browser signature (“User Agent”).

The local application directly displays information on the user's terminal without requiring a remote connection.

According to an alternative embodiment, an authorized user may access additional information available on a dedicated and secure site.

The authorized user reads a code printed on a physical support, for instance, a packaging, using a mobile terminal, for instance his/her cell phone.

The mobile terminal includes a specific application for reading QR codes which supplies the URL address saved in the acquired code.

The local application has a key which can decrypt, or means for obtaining a key, able to execute the decrypting, and a grammar, or means for obtaining a grammar, able to decode the parameter-conditional code of the URL.

The application uses such information so as to connect to another server than the operating server specified in the URL. This new destination enables the authorized user to obtain additional information which is not mentioned in the local code, in the initial operating code, but is only available from a dedicated and secure site.

According to an alternative embodiment, an authorized user may access additional information.

The authorized user reads a code printed on a physical support, for instance, a packaging, using a mobile terminal, for instance his/her cell phone.

The mobile terminal includes a specific application for reading QR codes which supplies the URL address saved in the acquired code.

The local application gets a key which can decrypt the parameter-conditional code of the URL, by reading another code printed on the physical support.

This may, for instance, be the reading of a second QR Code which enables the local decrypting of the first QR Code printed on the physical support.

This may, for instance, be a QR Code, the symbology of which is modified so as to contain information fit for decrypting the content of the QR Code.

This may, for instance, be a QR Code, the graphic representation of which is modified so as to contain information fit for decrypting the content of the QR Code.

This may, for instance, be the reading of another encoded information printed on the physical support, which will enable the local decoding of the QR Code printed on the same physical support.

The local application has a grammar, or means for obtaining a grammar, able to decode the conditional code as a parameter of the URL.

According to another alternative embodiment of the invention, the code validation requires entering additional information, which may be included in the support of the original code. Such additional information may consist of a second code which can be read with a different inclination of the support from the one enabling to read the original code.

This may, for instance, be a pattern implementing a holographic print or a lenticular network consisting of a main code and a secondary code, so as to enable the successive transmission of the main code and the secondary code, to the reader, from the same zone of the substrate.

An alternative embodiment relates to the production of physical supports the access to information of which depends on additional information. This may, for instance, be secure QR Codes, enabling a user to access a private content from the combination of the acquisition of data of a QR Code using his/her mobile phone and the entering of additional information.

For this purpose, a database is set up which comprises all the properties of each code: one identifier and, for instance, the expected value upon entering by the user, the type and length thereof, as well as an associated wording or wording reference.

A record is then extracted from the database, for each one of said codes. For each record, the various properties are encoded.

The expected value will then be encrypted using a dedicated algorithm similar to the managing of a password.

A prefix corresponding to the protocol and the address of the operating server is then associated to the encrypting of the numerical form obtained when associating the various encoded properties, in order to form a URL using a code.

The user then reads a code printed on a physical support, for instance a bank statement, using a mobile terminal, for instance his/her cell phone.

The mobile terminal includes a generic application for reading QR codes which supplies the URL address saved in the acquired code.

The reader launches the internet browser which connects to the operating server specified in the code.

This operating server decrypts and decodes the communicated parameter: the resultant of the expected value upon entering by the user, the type and the length thereof, as well as the associated wording.

The operating server generates a mobile internet page intended for the mobile user. Such page uses the wording prompt to enter the field, according to the typing and length rules previously defined. The user will enter this field into the form which will be sent back to the operating server.

The latter will apply the dedicated algorithm to the field entered by the user and will compare it with the resultant of the expected value obtained by the same algorithm contained in the code in order to authorize the following steps or not.

According to an alternative embodiment, the authorized user may access the static information written in the code, i.e. local data.

The authorized user reads a code printed on a physical support, for instance, a bank statement, using a mobile terminal, for instance his/her cell phone.

The mobile terminal includes a specific application for reading QR codes which supplies the URL address saved in the acquired code.

The local application has a key which can decrypt, or even a grammar which can decode the parameter-conditional code of the URL.

The local application directly displays information on the user's terminal without immediately requiring a remote connection.

The local application has a mobile interface intended for the mobile user.

Such interface uses the wording prompt to enter the field, according to the typing and length rules previously defined. The user will enter this field into the form.

The latter will apply the dedicated algorithm to the field entered by the user and will compare it with the resultant of the expected value obtained by the same algorithm contained in the code in order to authorize the following steps or not.

Another exemplary embodiment relates to the production of a set of physical supports, the access to information of which is limited by a number of accesses.

These may, for instance, be QR Codes, enabling a user to access a resource only once, or a limited number of times, using his/her mobile phone.

For this purpose, a main database is set up, which comprises all the properties of each code, an identifier, a maximum number of accesses, the destination URL for a valid condition, and the alternative destination URL.

A record is then retrieved from the database, for each one of said codes. The different properties are encoded for each record. A prefix corresponding to the protocol and the address of the operating server is then associated to the encrypting of the numerical form obtained in order to form a URL using a code.

Each URL is then used to execute the writing thereof on a physical support, for instance an optical reading code such as a QR code.

In parallel, new records are created in a temporary database or a memory space on the server, for each one of the previous records.

These codes are operated as explained hereunder.

The user reads a code printed on a physical support using a mobile terminal, for instance his/her cell phone.

The mobile terminal includes a QR code reading generic application which supplies the URL address saved in the acquired code.

The operating server executes, as in the general case, a code analysis with a view to retrieve the validity information and the destination URLs.

The validity information is verified not only with respect to the static information written in the code, i.e. local information, but as regards the information saved in the temporary base too.

Each validated access to the code results in the number of access decreasing till it reaches zero, when the system deletes the code saved in the temporary base.

Another alternative embodiment relates to the production of a set of physical supports, the access to information of which depends on the combination or the arrangement of the various supports.

These may, for instance, be QR Codes, enabling a user to access a private content from the acquisition of the respective data of a set of QR Codes, through a selection or in a sequence, using his/her mobile phone.

For this purpose, a database is set up which comprises all the properties of each code, among others: a code identifier, a validity period, the ordered list of the identifiers of the associated codes.

A record is than retrieved from the database, for each one of said codes. For each record, these various properties are encoded.

Each URL is than used to execute the writing thereof on a physical support, for instance an optical reading code such as a QR code.

These codes are operated as explained hereunder.

The user reads a code printed on a physical support, using his/her mobile phone, for instance a cell phone.

The mobile comprises a generic application for reading QR codes, which supplies the URL address saved in the acquired code.

The operating server executes, as in the general case, a code analysis with a view to retrieve among other things: a code identifier, a validity period, the list, whether ordered or not, of the identifiers of the associated codes.

The server writes and dates such record, in a temporary database, or in a dedicated memory space, or through a client cookie.

Than it reads all the records of the sequence, whether ordered or not, so as to check the access to the various identifiers within a predetermined time between the first and the last code, which is limited by the time-limiting parameter.

The system systematically deletes the expired temporary records, in the temporary database, in the dedicated memory space or through the security life of the client cookie determined by the time-limiting parameter.

According to an alternative solution of the previous embodiment, the user may access the static information written in the code, i.e. local data, through the reading of a code sequence, whether ordered or not.

The mobile terminal includes a specific application for reading QR codes which may locally process the method disclosed in details in the previous embodiment.

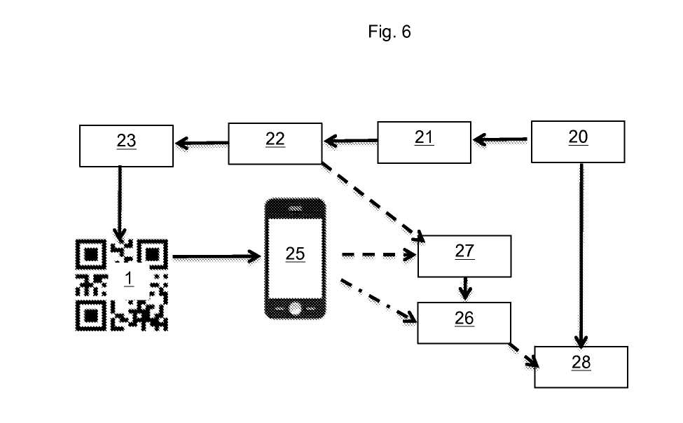

FIG. 6 shows a schematic view of the method for producing and operating the codes according to the invention.

A server 20 comprises a database set up for each record, with:

one or more address(es) of remote resource(s) fit to be associated with a code according to the invention, and corresponding to the address of the resource associated with the product whereon the physical representation of the code will be printed.

This is the address of the computer resource which the user's browser will access if the condition for validity determined from the second information is verified:

one or more validity criterion(ia) corresponding to the second information, comprising one or more following item(s) of information:

one or more validity period(s) expressed by one data or a time interval

a geographic zone defined by Cartesian coordinates and a distance, for instance

an identifier, for instance the GTIN or ISBN identifier of the corresponding product

a selection criterion of an address among a series of saved addresses corresponding to the first information.

A second equipment 21 (which may be the same server as 20) retrieves the above-mentioned records and encodes such data to provide a sequence of the URL type.

From such information, a sequence is calculated, which comprises:

a header corresponding to the address of the problem-solving server 8

an alphanumeric sequence calculated by a combination of one or more of said validity criteria and composing the “second information”. This calculation corresponds to the “second encoding”. It may be specific for one code operator, for all his/her products, or common to several operators. Such coding takes into account semantics and makes it possible to find the criteria through a local or remote decoding of such sequence.

Optionally, such sequence may be coded and/or encrypted. Then, it is encoded during a step 22, using a first coding, in order to create a physical representation, for instance using a coding so as to produce a file making it possible to generate a QR code or a NFC code.

The series of files thus prepared is then used by a physical code generator 23 in order to edit the physical representations 1 which will be printed on the corresponding products.

Such physical representation 1 may be usually operated by some equipment 25 executing either a standard application, or an application dedicated to the decrypting and/or decoding according to the invention. The result of the processing gives access to a computer resource 26, the address of which has been decrypted by the application. Optionally, an intermediary server 27 provides an address conversion, depending on whether the address is a short address or a physical address, according to a function table transmitted during step 22.

Prior to the validity test, the server 28 is polled in order to determine whether a modification has been brought during the steps of production of the physical representations.

1-17. (canceled)

18. A method for coding in a physical representation of a code an access to a computer resource encoded with a first coding type corresponding to an access path and to an identification of said computer resource, said code fit to be decoded by a reader of the physical representation, wherein:
said physical representation further comprises conditional validity information encoded with a second coding type corresponding to a condition for validity of the access to said computer resource,
with said conditional validity information fit to be decoded by an application installed in one element of a network comprising the reader of the physical representation, one or more gateway(s) and the server hosting said computer resource.

19. The method for coding the access to a computer resource according to claim 18, wherein said access is encoded with a code semantically representative of a field of application.

20. The method for coding the access to a computer resource according to claim 18, wherein said access path to the remote computer resource is calculated according to a combination of the identifier of a product on which said physical representation will be applied and descriptors characterizing said product.

21. The method for coding the access to a computer resource according to claim 18, wherein a physical representation of the code, first information encoded with a first coding type corresponding to the access path and to the identification of said computer resource, with said first information being able to be decoded by the reader, comprising:
said physical representation further comprises conditional validity information encoded with a second coding type, corresponding to a condition for validity of the access to said computer resource,
with said conditional validity information being able to be decoded by an application installed in an element of the network comprising the reader of the physical representation, one or more gateway(s) and the server hosting said computer resource.

22. The method for coding the access to a computer resource according to claim 18, wherein said conditional information is time information corresponding to at least one period of validity of the access to said computer resource.

23. The method for coding the access to a computer resource according to claim 18, wherein said conditional information is geographic information corresponding to geo-location information as compared to position information determined by the reader.

24. The method for coding the access to a computer resource according to claim 18, wherein said conditional information actuates a request for at least one additional data and the comparison with data associated with said conditional information.

25. The method for coding the access to a computer resource according to claim 18, wherein said conditional information actuates a request for at least one additional data and the comparison with data associated with said conditional information, within a predetermined response time.

26. The method for coding the access to a computer resource according to claim 23, wherein said conditional information actuates a request for at least one additional data and the comparison with data associated with said conditional information, according to the result of another request.

27. The method for coding the access to a computer resource according to claim 18, wherein said conditional information is processed by the reader, and not by the server.

28. The method for coding the access to a computer resource according to claim 18, wherein said conditional information is processed by the gateway, and not by the server.

29. A method for operating a code embedded in a physical representation and configured to give access to a computer resource encoded with a first coding type corresponding to an access path and to an identification of said computer resource, wherein:
said physical representation further comprises conditional validity information encoded with a second coding type corresponding to a condition for validity of the access to said computer resource,
with said conditional validity information fit to be decoded by an application installed in one element of a network comprising the reader of the physical representation, one or more gateway(s) and the server hosting said computer resource;
said method comprising decoding the code by a reader transmitting said first information to the network, when said reader has no computer resource to decode said conditional information and said first information is transmitted to the server corresponding to the access path only when the conditional information is validated by at least one of the elements of the network having a computer resource in order to decode said conditional information.

30. The method for operating a code according to claim 29, wherein the computer resource for decoding said conditional information comprises a grammar of a field of application.

31. The method for operating a code according to claim 29, wherein said reader comprises an application for decoding the conditional information in order to execute a local processing controlling a local interface according to the result of an analysis of said conditional information.

32. The method for operating a code according to claim 29, wherein said reader comprises an application for decoding the conditional information in order to execute a local processing controlling a remote action according to the result of an analysis of said conditional information.

33. The method for operating a code according to claim 29, wherein the computer resource for decoding said conditional information comprises at least a Database for saving exceptions to the condition of validity.

34. A hardware arrangement comprising a physical representation of a code with a first information encoded with a first coding type corresponding to an access path and to an identification of a computer resource, said code fit to be decoded by a reader, wherein:
said physical representation further comprises conditional validity information encoded with a second coding type corresponding to a condition for validity of an access to said computer resource,
with said conditional validity information fit to be decoded by an application installed in one element of a network including the reader of the physical representation, one or more gateway(s) and a server hosting said computer resource.
